(19) United States
(12) Patent Application Publication
(10) Pub. No.: US 2022/0343634 A1
(43) Pub. Date: Oct. 27, 2022

(54) PSEUDO DATA GENERATION APPARATUS, PSEUDO DATA GENERATION METHOD, AND NON-TRANSITORY STORAGE MEDIUM

(71) Applicant: Canon Medical Systems Corporation, Otawara-shi (JP)

(72) Inventor: Hidenori Takeshima, Kawasaki (JP)

(73) Assignee: Canon Medical Systems Corporation, Otawara-shi (JP)

(21) Appl. No.: 17/658,572

(22) Filed: Apr. 8, 2022

(30) Foreign Application Priority Data
Apr. 22, 2021 (JP) 2021-072757

(51) Int. Cl. G06V 10/774

(52) U.S. Cl. CPC G06V 10/774

(57) ABSTRACT

According to one embodiment, a pseudo data generation apparatus comprising processing circuitry. The processing circuitry collects a data set including data values of one or more dimensions. The processing circuitry performs conversion of the data values of the one or more dimensions included in the data set. The processing circuitry generates a pseudo physical parameter relating to each of one or more physical amounts.

### CROSS-REFERENCE TO RELATED APPLICATIONS

This application is based upon and claims the benefit of priority from Japanese Patent Application No. 2021-072757, filed Apr. 22, 2021, the entire contents of which are incorporated herein by reference.

### FIELD

Embodiments described herein relate generally to a pseudo data generation apparatus, a pseudo data generation method, and a non-transitory storage medium.

### BACKGROUND

Machine learning, such as deep neural networks, is based on an assumption of training with a large number of pieces of data, and has a drawback in that an expected performance may not be obtained if the number of pieces of data is insufficient. In the medical field in particular, from the viewpoint of privacy protection or the like, it is difficult to collect a large number of pieces of medical data of a wide variety, such as medical images. Therefore, when designing a machine learning model to be applied to the medical field, the number of pieces of data for training is likely to be insufficient and high-accuracy training is difficult.

### BRIEF DESCRIPTION OF THE DRAWINGS

FIG. 1 is a block diagram showing a pseudo data generation apparatus according to an embodiment.

FIG. 2 is a flowchart showing an operation example of the pseudo data generation apparatus according to the embodiment.

FIG. 3 is a conceptual diagram showing a first example of a specific generation process of a pseudo physical parameter,

FIG. 4 is a diagram showing an example of a usage application of a pseudo physical parameter.

FIG. 5 is a conceptual diagram showing a second example of a specific generation process of a pseudo physical parameter.

### DETAILED DESCRIPTION

In general, according to one embodiment, a pseudo data generation apparatus comprising processing circuitry. The processing circuitry collects a data set including data values of one or more dimensions. The processing circuitry performs conversion of the data values of the one or more dimensions included in the data set. The processing circuitry generates a pseudo physical parameter relating to each of one or more physical amounts.

Hereinafter, a pseudo data generation apparatus, a pseudo data generation method, and a non-transitory storage medium according to the embodiment will be described with reference to the drawings. In the embodiment described below, elements assigned the same reference symbols are assumed to perform the same operations, and redundant descriptions thereof will be omitted as appropriate. Hereinafter, the embodiment will be described with reference to the accompanying drawings.

### First Embodiment

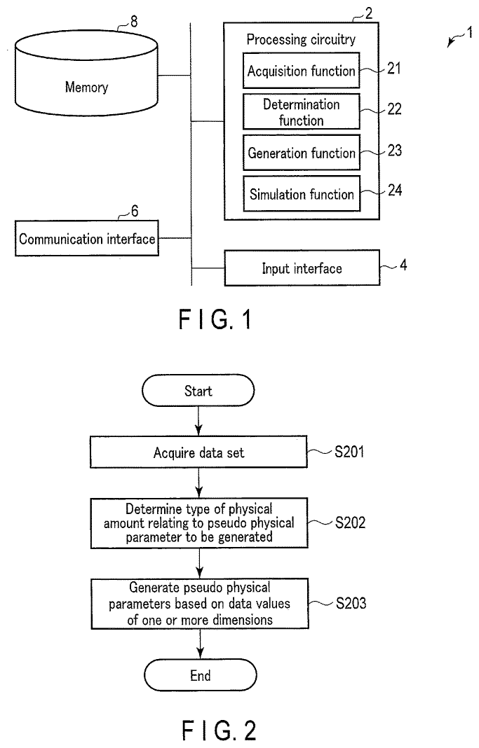

A pseudo data generation apparatus according to a first embodiment will be explained with reference to the block diagram of FIG. 1.

The pseudo data generation apparatus 1 according to the first embodiment includes processing circuitry 2, an input interface 4, a communication interface 6, and a memory 8.

The processing circuitry 2 includes an acquisition function 21, a determination function 22, a generation function 23, and a simulation function 24. The processing circuitry 2 includes a processor (not shown) as a hardware resource.

The acquisition function 21 collects a data set having data values of one or more dimensions. The data set is data of two or more dimensions, such as monochrome or color (RGB) dynamic image data, or time-series data of one or more dimensions. The dynamic image data is not limited to medical image data, but may be any kind of dynamic image, such as human images, landscape images, or animation images. The time-series data may be data that varies over time, such as voice data, seismic waveforms, electrocardiogram (ECG) waveforms, and stock charts, or a set of sampling values of such data.

If the aforementioned data set is image data, the data values of one or more dimensions include coordinate information and a pixel value in each pixel in the image data. If the aforementioned data set is time-series data, the data set includes a sampling value (plot data) in the time-series data.

The determination function 22 determines a type of one or more physical amounts which are pseudo physical parameters generated by the pseudo data generation apparatus 1.

The generation function 23 converts the data values of one or more dimensions included in the data set, and generates a pseudo physical parameter relating to each of the one or more physical amounts determined by the determination function 22. In other words, the pseudo physical parameters are values of physical amounts (parameters) artificially generated by data processing or the like.

The simulation function 24 executes magnetic resonance simulation using the pseudo physical parameter relating to each of the one or more physical amounts, and generates pseudo collection data simulating a magnetic resonance signal. The magnetic resonance simulation is a technique for simulatively acquiring MR signals collected using an input pulse sequence. In this embodiment, as the technique of the magnetic resonance simulation, a simulation using a Bloch equation, in which a macroscopic magnetization motion and a relaxation phenomenon are expressed, is explained as an example. However, the simulation technique is not limited thereto, but may be any technique as long as an MR signal can be simulated from input data, and detailed explanations for the simulation technique are omitted.

The input interface 4 includes a circuit that receives various types of instructions and information input from the user. The input interface 4 includes a circuit relating to, for example, a pointing device such as a mouse, or an input device such as a keyboard. The circuit included in the input interface 4 is not limited to a circuit relating to a physical operational component, such as a mouse or a keyboard. For example, the input interface 4 may include an electrical signal processing circuit which receives an electrical signal corresponding to an input operation from an external input device provided separately from the pseudo data generation apparatus 1 and outputs the received electrical signal to various circuits in the pseudo data generation apparatus 1.

The communication interface 6 executes data exchange with an external apparatus by wired or wireless connections.

The memory 8 stores data sets, pseudo physical parameters, pseudo collection data, a trained model, etc. The memory 8 is a semiconductor memory element, such as a random access memory (RAM) and a flash memory, a hard disk drive (HDD), a solid state drive (SSD), an optical disk, etc. The memory 8 may also be a drive apparatus or the like that reads and writes various information from and to a portable storage medium, such as a CD-ROM drive, a DVD drive, a flash memory, and the like.

The magnetic resonance simulation concerning the simulation function 24 of the processing circuitry 2 may be executed by an external apparatus. In this case, it suffices that a pseudo physical parameter is transmitted from the pseudo data generation apparatus 1 to the external apparatus via the communication interface 6, and the external apparatus executes the magnetic resonance simulation and generates pseudo collection data. The pseudo data generation apparatus 1 may receive the generated pseudo collection data from the external apparatus via the communication interface 6, and store it in the memory 8.

Various functions executed by the processing circuitry 2 may be stored in the memory 8 in the form of a program executable by a computer. In this case, the processing circuitry 2 is also considered a processor that reads programs corresponding to the various functions from the memory 8 and executes them to realize functions corresponding to the programs. In other words, the processing circuitry 2 that has read the programs has, for example, the functions shown in the processing circuitry 2 depicted in FIG. 1.

FIG. 1 illustrates the case where the various functions are realized in single processing circuitry 2; however, the processing circuitry 2 may be constituted by a combination of a plurality of independent processors, and the functions may be realized by the processors respectively executing the programs. In other words, the above-described functions may be configured as programs, and executed by single processing circuitry; alternatively, the functions may be implemented in independent program-execution circuitry specific to the respective functions.

Next, an operation example of the pseudo data generation apparatus 1 according to the first embodiment will be described with reference to the flowchart of FIG. 2. Although a case of processing one data set is described herein, the pseudo data generation apparatus 1 may acquire a plurality of data sets, execute similar processing for each of the data sets, and generate one or more pseudo physical parameters for each data set.

In step S201, the processing circuitry 2 acquires a data set through the acquisition function 21. The data set may be a set having a plurality of data values of one or more dimensions, namely, one or more channels. For example, the data set may be two-dimensional data, which has a piece of data in each dimension. Focusing on pixels in a case where the data set constitutes an image, it is considered that the data set includes pieces of three-dimensional data of the number corresponding to the number of pixels, each piece of three-dimensional data including a pixel value and two-dimensional (horizontal and vertical) coordinates information (for example, three-dimensional sequence data of [a pixel value, an x-coordinate, a y-coordinate]) of each pixel. Similarly, in a case where the data set constitutes an RGB image, it is considered that the data set includes five-dimensional data of the number corresponding to the number of pixels, each piece of five-dimensional data including three pixel values of R, G, and B, and two-dimensional (horizontal and vertical) coordinates information ([an R value, a G value, a B value, an x-coordinate, a y-coordinate]) of each pixel.

In step S202, the processing circuitry 2 determines through the determination function 22 the type of the physical amount of the physical parameter to be generated. The type of the physical amount may be determined, for example, based on the user's instruction input via the input interface 4 or may be set by default. Furthermore, a combination of usage application for generating a pseudo physical parameter and one or more physical amounts required for the usage application may be stored in advance in the memory 8 or the like, in which case, when the user selects the usage application, the corresponding one or more physical amounts can be determined.

Specifically, in the case of generating pseudo physical parameters of physical amounts required for magnetic resonance simulation using a Bloch equation, it suffices that the processing circuitry 2 determines, through the determination function 22, types of physical amounts, such as a value M0 proportional to the number of protons, a longitudinal relaxation time T1, a transverse relaxation time T2, a resonance frequency F0, and a diffusion coefficient D. The value M0 proportional to the number of protons may be a value of thermal equilibrium magnetization including, for example, an influence of a proton density. As the diffusion coefficient D, a pseudo physical parameter may be determined for each of the components of a diffusion tensor, such as Dₓₓ, D_{xy}, D_{yy}, and Dₓₓ.

In step S203, the processing circuitry 2 generates pseudo physical parameters of one or more physical amounts determined in step S202 through the generation function 23 based on the data values of one or more dimensions included in the data set. As a method for generating pseudo physical parameters, it suffices that, for example, a value obtained by converting the data values of one or more dimensions is set as a pseudo physical parameter corresponding to the physical amount determined in step S202. The conversion process executed through the generation function 23 may be linear conversion or non-linear conversion. The linear conversion is a linear sum of data values of one or more dimensions. The non-linear conversion is a process of generating pseudo physical parameters corresponding to one or more physical amounts using a model of, for example, a deep neural network, to which one or more pieces of data is input, and which outputs the trained model trained to output one or more pseudo physical parameters for the input data.

All pseudo physical parameters are not necessarily calculated by the conversion process. As long as a pseudo physical parameter does not need to have variations in the value as a physical amount, a random value or a predetermined value may be allocated to the physical amount. For example, of the six physical amounts, M0, T1, T2, Dₓₓ, D_{xy} and D_{yy}, pseudo physical parameters may be generated for M0, T1 and T2 by the conversion process, and random values may be allocated to Dₓₓ, D_{xy} and D_{yy}.

A plurality of pseudo physical parameters may be generated for each of one or more physical amounts. For example, with regard to a physical amount of the value M0 proportional to the number of protons, two linear sums having different coefficients of the data values of one or more dimensions may be obtained, so that two different pseudo physical parameter can be generated.

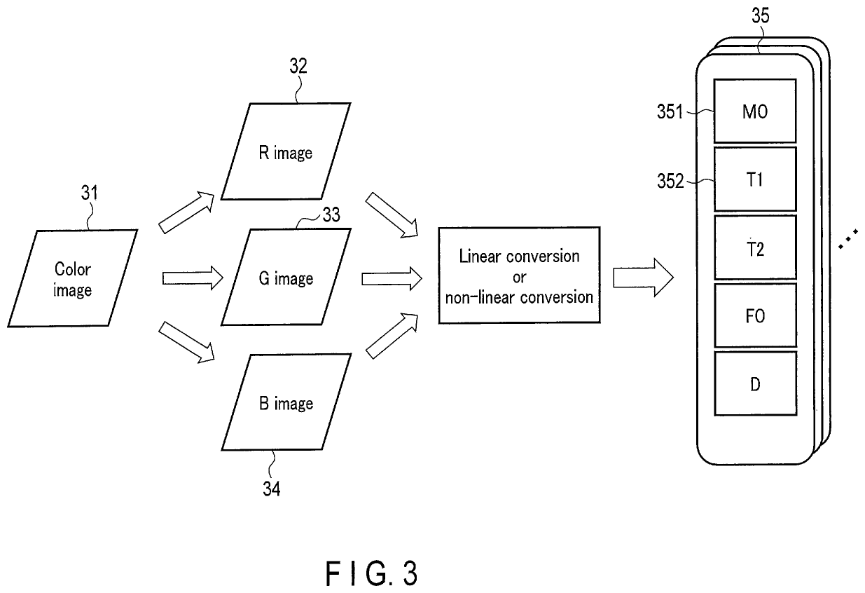

A first example of a specific process for generating a pseudo physical parameter through the generation function 23 will be explained with reference to the conceptual diagram of FIG. 3.

FIG. 3 shows a case of generating a pseudo physical parameter set 35, which is a set of pseudo physical parameters 351 respectively corresponding to physical amounts, on the assumption of a color image 31 having 256×256 pixels as a data set. Here, the physical amounts are assumed to be five physical amounts M0, T1, T2, F0, and D.

The color image 31 is a three-channel image of RGB, and decomposed into RGB component images, namely, an R image 32, a G image 33, and a B image 34. The process of decomposition into the respective component images may be executed with a general image processing method; therefore, explanations thereof are omitted.

Subsequently, through the generation function 23, the processing circuitry 2 executes the linear conversion for each of the R image 32, the G image 33, and the B image 34 to calculate the pseudo physical parameters 351 of the respective physical amounts, thereby generating a single pseudo physical parameter set 35. In other words, a pixel value of the same coordinates is extracted from each of the R image 32, the G image 33, and the B image 34, and a linear sum of the extracted three pixel values is calculated. Specifically, assuming that a horizontal direction of the image is defined as an x-axis, a vertical direction of the image is defined as a y-axis, and upper left coordinates are represented as (x,y)=(1,1), a pixel value of a pixel corresponding to the coordinates (1,1) of each of the R image 32, the G image 33, and the B image 34 is extracted, and data values of one or more dimensions, three-dimensional data [(the pixel value of the R image), (the pixel value of the G image), (the pixel value of the B image)] in this embodiment, is obtained. The first physical amount, namely, the pseudo physical parameter 351 of the value M0 proportional to the number of protons, is generated from the linear sum of the extracted pixel values. For example, the parameter may be calculated from the linear sum of F(M0)=0.5×(the pixel value of the R image)+0.3×(the pixel value of the G image)+0.2×(the pixel value of the B image).

Next, the second physical amount, namely, the pseudo physical parameter 352 of the longitudinal relaxation time T1, is generated using the aforementioned three—dimensional data. For example, the pseudo physical parameter 352 may be calculated from the linear sum with different coefficients of F′ (T1)=500×(the pixel value of the R image)+1000×(the pixel, value of the G image)+200×(the pixel value of the B image). Thus, the pseudo physical parameter set 35 can be obtained by generating the pseudo physical parameters of the physical amounts, such as the transverse relaxation time T2, the resonance frequency F0, and the diffusion coefficient D, using the same three-dimensional data.

Next, a pixel value of the coordinates (2,1) to the right of the coordinates (1,1) of each of the R image 32, the G image 33, and the B image 34 is extracted to obtain next three-dimensional data. With regard to the next three-dimensional data, the pseudo physical parameter 351 of the value M) proportional to the number of protons can be calculated from the linear sum obtained by the function F(M0), and the pseudo physical parameter 352 of the longitudinal relaxation time T1 can be calculated from the linear sum obtained by the function F′ (T1). Thus, the pseudo physical parameters are sequentially generated, thereby obtaining the pseudo physical parameter set 35.

In this manner, the pseudo physical parameters of the respective physical mounts are calculated from the pixel values of the respective pixels. As a result, from the color image of 256×256 pixels, 256×256=65536 pseudo physical parameter sets 35 can be generated.

Alternatively, a pseudo physical parameter may be calculated from a pixel value of a partial image (also referred to as a patch), which is an extract of an area from the entire image, instead of the pixel value of each pixel. As the pixel value of a patch, an average pixel value of a plurality of pixels in the patch may be adopted as the pixel value of each component image (the R image, the G image, or the B image). Alternatively, a pixel value of each of the pixels in the patch may be adopted, so that a pseudo physical parameter may be generated from a linear sum obtained by a function of multiplying a coefficient by the pixel value of each pixel in the patch. In the case of generating a plurality of pseudo physical parameter sets 35 from an image using a patch, a larger number of pseudo physical parameter sets 35 can be generated by suitably setting a so-called stride of the patch. For example, a data value may be extracted using a patch of the 8×8 size from the entire image of the 256×256 size with a stride of “1”, and then with a stride of “2”. Since the combination of pixel values in the patch is changed by changing the stride, a larger number of pseudo physical parameter sets 35 can be generated.

The coefficients in the functions described above may be set to any values, as long as the values of the calculation results meet the physical limitations of the pseudo physical parameters. In other words, the pseudo physical parameters may be determined in whatever manner as long as the values meet the physical limitations. Specifically, for example, the longitudinal relaxation time T1 cannot have a negative value under the laws of physics, but any number that meets the limitation T1>0 can be used as the pseudo physical parameter 352 of the longitudinal relaxation time T1. The pseudo physical parameters may be limited in value range depending on the circumstances in which the physical values can be observed.

In the case where the data set is time-series data, a pseudo physical parameter can be generated from the data values of one or more dimensions, using, for example, a plurality of sampling values. Specifically, the pseudo physical parameter corresponding to a physical amount may be calculated from the linear sum obtained by F(M0)=0.5×(a first sampling value)+0.3×(a second sampling value)+0.2×(a third sampling value).

The conversion is not limited to the linear conversion described above. For example, in the case of the non-linear conversion using a trained model of a neural network, a trained model which is trained so as to receive a pixel value of each component image as an input and output an unknown value is prepared in advance. Thereafter, the trained model is applied to the R image, the G image, and the B image, so that the value output from the trained model can be used as a pseudo physical parameter. The trained model may have any network structure that can output any value with respect to an input. For example, a generator of a conditional generative adversarial network (GAN) may be applied to the RGB images, so that a pseudo physical parameter can be output.

The number of values to be output from the trained model may be greater than the number of types of the physical amounts, for example, determined in step S202, so that during inference of the trained model, outputs of the number corresponding to the number of types of the physical amounts determined in step S202 can be extracted. Alternatively, if the number of types of the physical amounts to be generated is known in advance, the model may be trained so as to obtain outputs of the same number as that of the types.

Furthermore, the number of outputs from the trained model may be one and the trained model may be applied a plurality of times, so that pseudo physical parameters of the same number as that of the types of the physical amount determined in step S202 can be generated. For example, in the case of using a generator of a conditional GAN, a trained model may be applied a plurality of times, since different outputs can be obtained by inputting a random value as a seed, even if the same pixel value is input.

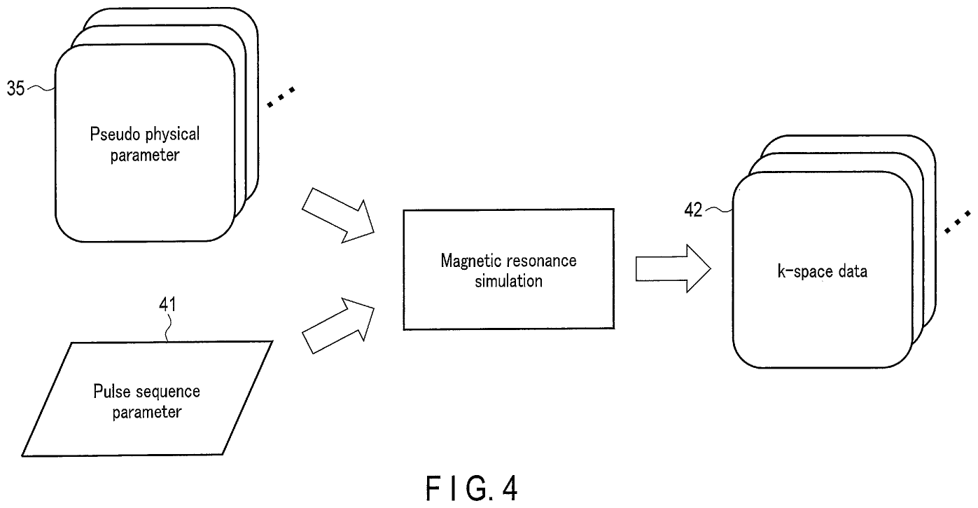

Next, an example of a usage application of the generated pseudo physical parameters through the simulation function will be explained with reference to FIG. 4.

For example, the pseudo physical parameter sets 35 generated by the process shown in FIG. 3 and a pulse sequence 41 are used in combination, and magnetic resonance simulation using a Bloch equation is executed. The pulse sequence and the pseudo physical parameters corresponding to the physical amounts of M0, T1, T2, etc. are incorporated into a Bloch equation, and an MR signal collected by the input pulse sequence can be theoretically calculated by solving the Bloch equation. Briefly, protons are located in a simulation space according to a field of view (FOV), and a precessional motion of the protons is analyzed. If the FOV is 256 [mm], it suffices that 256×256 pseudo physical parameters generated based on each pixel are arranged according to the FOV. As a result, a simulation value of k-space data (hereinafter referred to simply as k-space data 42) can be generated from the pseudo physical parameter sets 35.

With regard to a parameter other than the pseudo physical parameters and relating to measurement conditions, such as transmission sensitivity and reception sensitivity, necessary in the magnetic resonance simulation, a predetermined value may be set or a value measured by an actual device may be set as such a parameter.

The generated k-space data 42 may be used as training data in various types of machine, learning. Specifically, the k-space data 42 may be used for training of an image reconstruction model which receives the k-space data 42 as an input and outputs a reconstructed image. Furthermore, the k-space data 42 may be used for training of a model of a transfer source of transfer learning in which a trained model in one domain is utilized for training in another domain. Alternatively, the k-space data 42 may be used as test data for training performance prediction or transfer effect prediction. The k-space data 42 may also be used as test data relating to product tests for determining whether data can be normally transmitted from a magnetic resonance imaging (MRI) apparatus to, for example, a picture archiving and communication system (PACS) in the format of digital imaging and communications in medicine (DICOM). Furthermore, the k-space data 42 may be used for usage applications of research or education, such as simulation of reconstruction processing using k-space data. In a usage application of test data or the like which does not require such an accuracy as required for actual clinical data, pseudo collection data and actual clinical data, for example, k-space data actually imaged by an MRI apparatus, may be used in a mixed state.

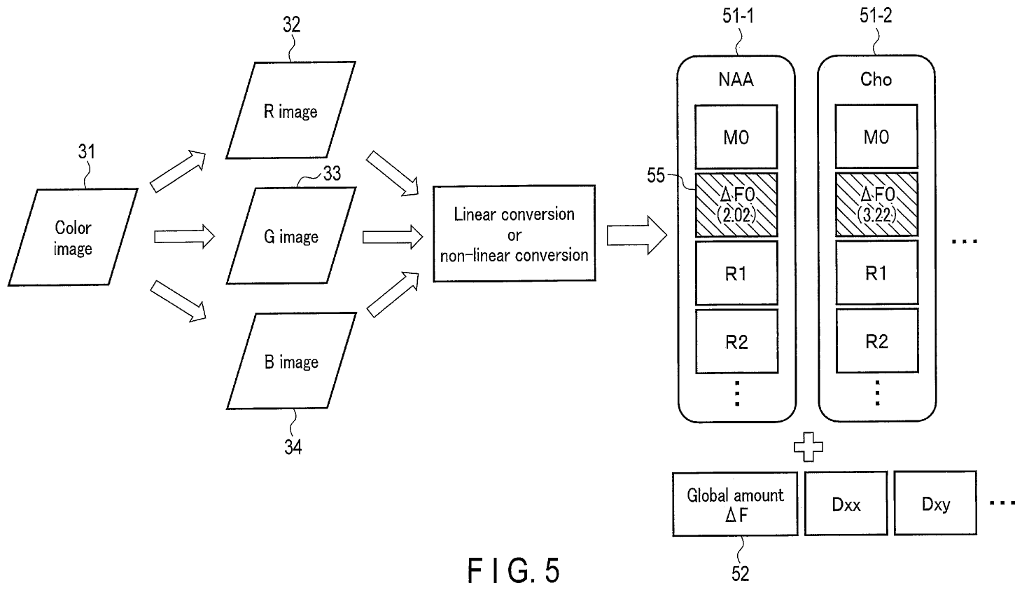

A second example of a process for generating a pseudo physical parameter will be explained with reference to FIG. 5.

FIG. 5 shows an example of generating a pseudo physical parameter set 51 relating to magnetic resonance spectroscopy (MRS), which is a type of chemical shift measurement, using the color image 31 as the data set. The MRS is a measurement method for acquiring biochemical information utilizing a small difference in resonance frequency between molecules which are metabolites in a living body as a target and a signal intensity (peak; mainly reflecting the number of protons. The MRS can visualize the amount of metabolites in the living body existing in a measurement target area (voxel of interest: VOI). Examples of the molecules which are metabolites include N-acetylaspartic acid (NAA), choline (Cho), and creatine (Cr).

The method for generating a pseudo physical parameter is similar to that in the first example described above; that is, each pixel in an R image 32, a G image 33, and a B image 34 is converted to generate a pseudo physical parameter of a physical amount necessary to obtain MRS data of molecules. Examples of the physical amount necessary to obtain MRS data include a value M0 proportional to the number of protons, a chemical shift amount ΔF0 representing the amount of shift from the resonance frequency as a reference, a longitudinal relaxation time T1 or a longitudinal relaxation rate R1 (=1/T1), a transverse relaxation time T2 or a transverse relaxation rate R2 (=1/T2), a diffusion coefficient D, etc.

The chemical shift amount ΔF0 is known as a value specific to each molecule. For example, a main chemical shift amount of NAA is 2.02 ppm, and a main chemical shift amount of Cho is 3.02 ppm. Therefore, the chemical shift amount ΔF0 may be determined from a look-up table storing, for example, a molecule and a chemical shift amount ΔF0 in association with each other.

In addition to the chemical shift amount ΔF0 specific to each molecule, a global amount ΔF representing a chemical shift amount entirely contributing when MRS data is obtained may be set. Furthermore, the global amount ΔF may be set as a predetermined value or a random value. The diffusion coefficient D may also be set as a predetermined value or a random value.

Referring to FIG. 5, specifically, with regard to two molecules “NAA” and “Cho”, it is assumed that the chemical shift amount ΔP0 is determined from the look-up table, and preset values are given to the global amount ΔF and the diffusion coefficient D. With regard to the other physical amounts, namely, the value M0 proportional to the number of protons, the longitudinal relaxation rate R1, and the transverse relaxation rate R2, the processing circuitry 2 converts each pixel in the R image 32, the G image 33, and the B image 34, to generate a pseudo physical parameter set 51-1 of “NAA” and a pseudo physical parameter set 51-2 of “Cho” through the generation function 23.

A, predetermined value or a random value may be allocated to each of the longitudinal relaxation rate R1 and the transverse relaxation rate R2 instead of generating these rates from the data set. Specifically, the longitudinal relaxation rate R1 and the transverse relaxation rate R2 for the pseudo physical parameter set of “NAA” may be set, and the longitudinal relaxation rate R1 and the transverse relaxation rate R2 for the pseudo physical parameter set of “Cho” may be set.

The generated pseudo physical parameter sets, a pulse sequence for acquiring MRS data, and data collection conditions for acquiring the MRS data are incorporated into a Bloch equation. A simulated MR signal is generated by solving the Bloch equation. The data collection conditions include condition items of a repetition time (TR), an echo time (TE), the number of times of integration, a spectrum width, the number of samplings, a data collection method, an area selection pulse, etc. As a pulse sequence for acquiring MRS data, for example, point resolved spectroscopy (PRESS) and a stimulated echo acquisition mode (STEAM) are known. The generated MR signal is subjected to preprocessing, such as low-pass filtering, and thereafter Fourier conversion, thereby generating an MRS spectrum.

Since the MRS spectrum obtained through the aforementioned pseudo physical parameter sets is based on pseudo physical parameters of specific molecules, a simulation value of signal intensity corresponding to the other chemical shift amount may be missing. Therefore, a trained model trained to fill in a missing simulation value may be applied to generate an MRS spectrum.

The trained model for filling in a missing simulation value may be generated, for example, by training a model with training data using an actually measured MRS spectrum as ground truth data, and using a spectrum as input data which is obtained by blinding (blanking) the portions other than the signal intensity corresponding to the chemical shift of the metabolites from the spectrum of the ground truth data.

The pseudo physical parameters obtained for each molecule as shown in FIG. 5 may be used for simulation of physical properties of the molecule, not only for obtaining the MRS spectrum. Furthermore, they may ne used for generating chemical shift imaging (CST) data by distributing spectrums obtained by MRS simulation relating to a plurality of VOIs.

The pseudo data generation apparatus 1 according to the present embodiment is assumed to be connected to an MRI apparatus or a PACS server, which handles k-space data. However, the pseudo data generation apparatus 1 may generate pseudo data relating to physical amounts handled by a medical image diagnosis apparatus of another type. For example, the pseudo data generation apparatus 1 may be connected to any of a computed tomography (CT) apparatus, an X-ray imaging apparatus, a positron emission tomography (PET) apparatus, a single photon emission computed tomography (SPECT) apparatus, an ultrasonic diagnosis apparatus, or the like, and may generate pseudo physical parameters corresponding to physical amounts relating to medical data acquired by the connected medical image diagnosis apparatus.

Specifically, the atomic number (effective atomic number) of an atom composing a body tissue, an electron density, an amount of incident X-rays, a tube voltage, etc. are known as physical amounts relating to projection data obtained by a CT apparatus. In the same manner as in the case described above, pseudo physical parameters relating to physical amounts of the atomic number are generated, and with regard to the generated pseudo physical parameters, pseudo projection data can be generated through a projection process corresponding to an amount of incident X-rays and a linear attenuation coefficient of the X-rays.

The pseudo data generation apparatus 1 may be mounted on at least one of a server, a workstation, and a medical image diagnosis apparatus.

According to the embodiment described above, a pseudo physical parameter corresponding to each of one or more physical amounts is generated by converting data values of one or more dimensions included in data sets of a wide variety. As a result, many parameters relating to the physical amounts can be prepared. By performing, for example, magnetic resonance stimulation using many pseudo physical parameters, many pieces of pseudo collection data can be generated. Accordingly, many data sets can be prepared in the medical field, where the number of pieces of data is likely to be insufficient. Therefore, if it is unnecessary or difficult to use actual data in a usage application, such as machine learning, product tests, education, etc., pseudo physical parameters can be used, thereby improving the accuracy in machine learning and the test accuracy.

In the machine learning models in many usage applications, the learning performance is higher in the following order from (1) to (4): (1) data corresponding to the usage application of the model; (2) data completely compatible with the data corresponding to the usage application of the model; (3) data not completely compatible with the data corresponding to the usage application of the model but having a similar characteristic; and (4) data completely dissimilar to the data corresponding to the usage application of the model (for example, random data).

Thus, generating pseudo physical parameters from data having a meaningful structure, such as image data or time-series data, and learning with pseudo collection data based on the pseudo physical parameters can improve the learning performance of the machine learning model in tasks such as classification or segmentation of medical images as compared to generating pseudo physical parameters from random data.

According to at least one embodiment described above, data can be generated more efficiently.

Furthermore, the functions described in connection with the above embodiment may be implemented, for example, by installing a program for executing the processing in a computer, such as a workstation, etc., and expanding the program in a memory. The program that causes the computer to execute the processing can be stored and distributed by means of a storage medium, such as a magnetic disk (a hard disk, etc.), an optical disk (CD-ROM, DVD, etc.), and a semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A pseudo data generation apparatus comprising processing circuitry configured to:
collect a data set including data values of one or more dimensions; and
perform conversion of the data values of the one or more dimensions included in the data set, and
generate a pseudo physical parameter relating to each of one or more physical amounts.

2. The pseudo data generation apparatus according to claim 1, wherein the conversion is a linear sum of the data values of the one or more dimensions.

3. The pseudo data generation apparatus according to claim 1, wherein the conversion is performed by applying a trained model to the data values of the one or more dimensions, the trained model being trained so as to receive one or more pieces of data as an input and output one or more pseudo physical parameters.

4. The pseudo data generation apparatus according to claim 1, wherein:
the data set is image data; and
the data values of the one or more dimensions include coordinate information and a pixel value in each pixel in the image data.

5. The pseudo data generation apparatus according to claim 4, wherein:
one of the one or more physical amounts is a value proportional to a number of protons; and
the processing circuitry generates the pseudo physical parameter relating to the value proportional to the number of protons from the pixel value in the each pixel.

6. The pseudo data generation apparatus according to claim 1, wherein:
the data set is time-series data; and
the data values of the one or more dimensions include a sampling value in the time-series data.

7. The pseudo data generation apparatus according to claim 1, wherein the processing circuitry generates the pseudo physical parameter by allocating a predetermined value or a random value to some of the one or more physical amounts.

8. The pseudo data generation apparatus according to claim 1, wherein the one or more physical amounts are physical amounts for use in magnetic resonance simulation using a Bloch equation.

9. The pseudo data generation apparatus according to claim 1, wherein the one or more physical amounts include a value proportional to a number of protons, a longitudinal relaxation time or a longitudinal relaxation rate, and a transverse relaxation time or a transverse relaxation rate.

10. The pseudo data generation apparatus according to claim 1, wherein the one or more physical amounts are physical amounts for use in simulation relating to chemical shift measurement of molecules including metabolites in a living body.

11. The pseudo data generation apparatus according to claim 10, wherein the processing circuitry sets, for each of the molecules, a chemical shift amount specific to a molecule, and
generates the pseudo physical parameters for each of the molecules relating to a value proportional to a number of protons, a longitudinal relaxation time or a longitudinal relaxation rate, and a transverse relaxation time or a transverse relaxation rate.

12. The pseudo data generation apparatus according to claim 1, wherein the processing circuitry is further configured to execute magnetic resonance simulation using the pseudo physical parameters relating to each of the one or more physical amounts, and generate pseudo collection data simulating a magnetic resonance signal.

13. The pseudo data generation apparatus according to claim 1, wherein:
the one or more physical amounts are physical amounts relating to X-ray computed tomography including at least one of an atomic number and an effective atomic number; and
the processing circuitry generates the pseudo physical parameters relating to at least one of the atomic number and the effective atomic number.

14. The pseudo data generation apparatus according to claim 13, the processing circuitry is further configured to generate pseudo projection data through a projection process corresponding to an amount of incident X-rays and a linear attenuation coefficient of the X-rays for the pseudo physical parameters.

15. A pseudo data generation method comprising:
collecting a data set including data values of one or more dimensions;
converting the data values of the one or more dimensions included in the data set; and
generating a pseudo physical parameter relating to each of one or more physical amounts.

16. A non-transitory storage medium storing a program that causes processing circuitry to:
collect a data set including data values of one or more dimensions; and
convert the data values of the one or more dimensions included in the data set; and
generate a pseudo physical parameter relating to each of one or more physical amounts.
